(19) United States
(12) Patent Application Publication
(10) Pub. No.: US 2014/0067641 A1
(43) Pub. Date: Mar. 6, 2014

(54) INFORMATION PROCESSING SYSTEM, INFORMATION PROCESSING APPARATUS, AND COMPUTER READABLE MEDIUM

(71) Applicant: FUJI XEROX CO., LTD., Tokyo (JP)

(72) Inventor: Masaru FUJII, Kanagawa (JP)

(73) Assignee: FUJI XEROX CO., LTD., Tokyo (JP)

(21) Appl. No.: 13/738,497

(22) Filed: Jan. 10, 2013

(30) Foreign Application Priority Data
Aug. 29, 2012 (JP) 2012-189286

(51) Int. Cl. G06Q 40/04

(52) U.S. Cl. CPC G06Q 40/04
USPC 705/37

(57) ABSTRACT

An information processing system includes a desired commodity-purchase-information acquisition unit that acquires pieces of desired commodity purchase information each including a desired purchase condition for a commodity, a desired commodity-selling-information acquisition unit that acquires desired commodity selling information including a desired selling condition for the commodity, a difference acquisition unit that acquires a difference obtained by subtracting a desired selling price obtained on the basis of the desired selling information from a desired purchase price obtained on the basis of the desired commodity purchase information for each of the pieces of desired commodity purchase information, and a determination unit that performs determination and that accepts one or more of the pieces of desired commodity purchase information for which the total of the differences is equal to or more than zero, as those for which sales are to be made, on the basis of the differences.

### CROSS-REFERENCE TO RELATED APPLICATIONS

This application is based on and claims priority under 35 USC 119 from Japanese Patent Application No. 2012-189286 filed Aug. 29, 2012.

### BACKGROUND

### Technical Field

The present invention relates to an information processing system, an information processing apparatus, and a computer readable medium.

### SUMMARY

According to an aspect of the invention, there is provided an information processing system including a desired commodity-purchase-information acquisition unit, a desired commodity-selling-information acquisition unit, a difference acquisition unit, and a determination unit. The desired commodity-purchase-information acquisition unit acquires multiple pieces of desired commodity purchase information, each of which includes a desired purchase condition for a commodity. The desired commodity-selling-information acquisition unit acquires desired commodity selling information including a desired selling condition for the commodity. The difference acquisition unit acquires a difference obtained by subtracting a desired selling price from a desired purchase price for each of the pieces of desired commodity purchase information. The desired selling price is obtained on the basis of the desired selling information. The desired purchase price is obtained on the basis of the desired commodity purchase information. The determination unit performs determination and accepts one or more pieces of desired commodity purchase information which are at least one of the pieces of desired commodity purchase information and for which the total of the differences is equal to or more than zero, as desired commodity purchase information for which sales are to be made, on the basis of the difference obtained for each of the pieces of desired commodity purchase information.

### BRIEF DESCRIPTION OF THE DRAWINGS

Exemplary embodiment of the present invention will be described in detail based on the following figures, wherein:

FIG. 1 is a diagram illustrating an information processing system according to an exemplary embodiment of the present invention;

FIG. 2 is a diagram illustrating exemplary desired commodity selling information transmitted by a seller-side user terminal;

FIG. 3 is a diagram illustrating exemplary desired commodity purchase information transmitted by purchaser-side user terminals;

FIG. 4 is a diagram illustrating the configuration of a management apparatus according to the exemplary embodiment;

FIG. 5 is a diagram illustrating an example of associated costs and selling prices;

FIG. 6 is a diagram illustrating an example of differences obtained by a difference acquisition unit;

FIG. 7 is a diagram describing a determination process performed by a determination unit;

FIG. 8 is a flowchart of a determination process in the information processing system according to the exemplary embodiment; and

FIG. 9 is a diagram describing an effect achieved in the configuration according to the exemplary embodiment.

### DETAILED DESCRIPTION

An exemplary embodiment of the present invention will be described in detail below on the basis of the drawings.

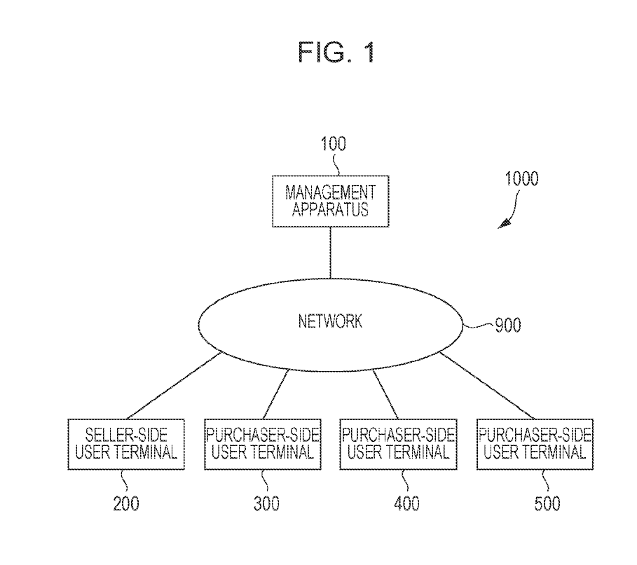

FIG. 1 is a diagram illustrating an information processing system 1000 according to an exemplary embodiment of the present invention.

The information processing system 1000 includes a management apparatus 100, a seller-side user terminal 200, purchaser-side user terminals 300, 400, and 500 which are connected to each other via a network 900. The management apparatus 100, the seller-side user terminal 200, and the purchaser-side user terminals 300, 400, and 500 are information processing apparatuses such as personal computers.

The information processing system 1000 has the seller-side user terminal 200 operated by a seller who sells certain commodities, and the purchaser-side user terminals 300, 400, and 500 operated by purchasers who wish to purchase the commodities, and manages determination of whether or not the sales are to be made for the commodities.

The management apparatus 100 receives desired commodity selling information transmitted from the seller-side user terminal 200 and pieces of desired commodity purchase information transmitted from the purchaser-side user terminals 300, 400, and 500, and accepts at least some of the pieces of desired commodity purchase information as those for which sales are to be made, on the basis of the desired commodity selling information and the desired commodity purchase information which have been received. The configuration of the management apparatus 100 and processes performed in the management apparatus 100 will be described below.

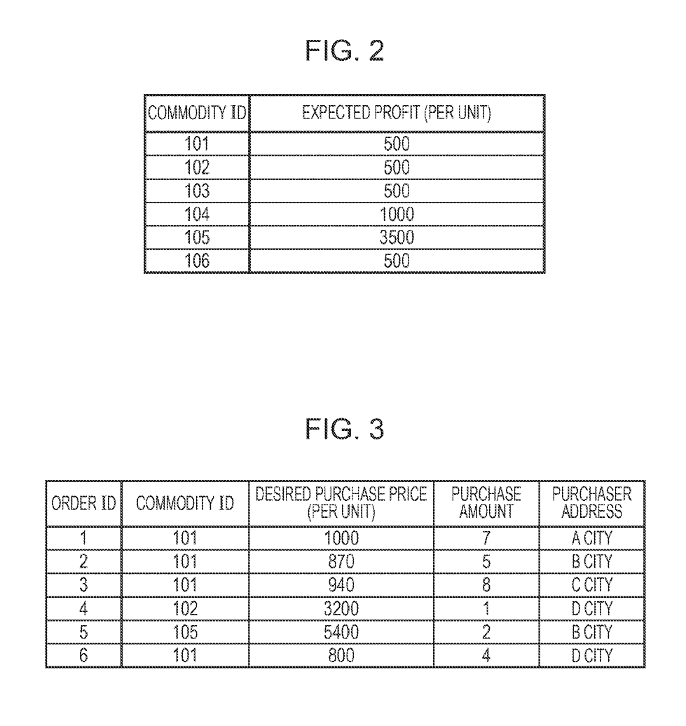

On the basis of operations by a seller who wishes to sell certain commodities, the seller-side user terminal 200 obtains desired commodity selling information which describes the sale of the commodities and which includes desired selling conditions from the seller, and transmits it to the management apparatus 100 via the network 900. FIG. 2 is a diagram illustrating exemplary desired commodity selling information transmitted by the seller-side user terminal 200. The desired commodity selling information includes an expected per-unit profit (gross profit) earned through a sale for each of the commodities.

On the basis of operations by purchasers who wish to purchase certain commodities, the purchaser-side user terminals 300, 400, and 500 obtain desired commodity purchase information which describes the purchase of the commodities and which includes desired purchase conditions from the purchasers, and transmit it to the management apparatus 100 via the network 900. FIG. 3 is a diagram illustrating exemplary desired commodity purchase information transmitted by the purchaser-side user terminals 300, 400, and 500. The desired commodity purchase information includes an order ID, the commodity ID of a commodity which a purchaser wishes to purchase, a desired per-unit price, a purchase amount, and a purchaser address (delivery address).

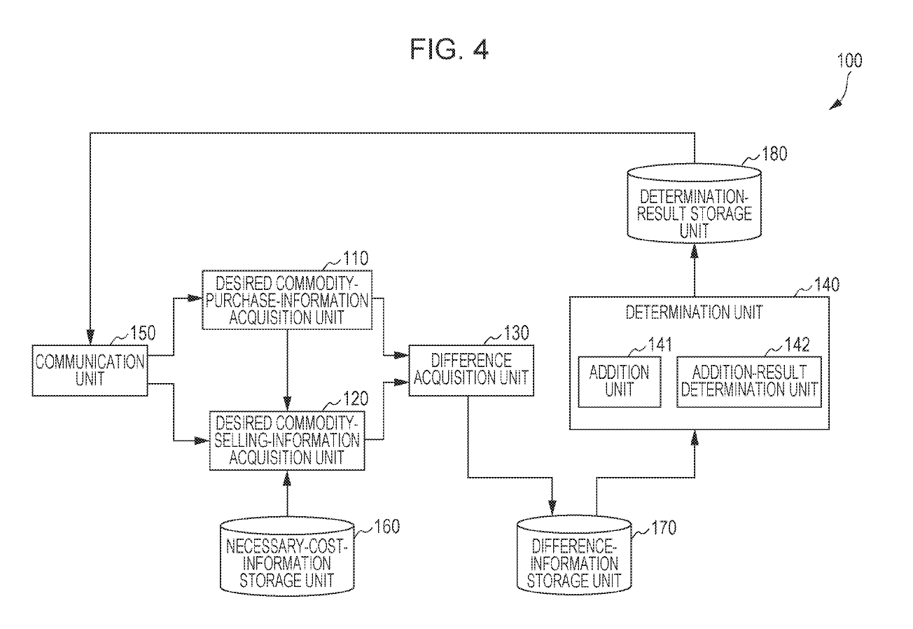

The configuration and operations of the management apparatus 100 will be described. FIG. 4 is a diagram illustrating the configuration of the management apparatus 100 according to the present exemplary embodiment. The management apparatus 100 includes a desired commodity-purchase-information acquisition unit 110, a desired commodity-selling-information acquisition unit 120, a difference acquisition unit 130, a determination unit 140, a communication unit 150, a necessary-cost-information storage unit 160, a difference-information storage unit 170, and a determination-result storage unit 180. The determination unit 140 includes an addition unit 141, and an addition-result determination unit 142. The desired commodity-purchase-information acquisition unit 110, the desired commodity-selling-information acquisition unit 120, the difference acquisition unit 130, the determination unit 140, and the communication unit 150 each are achieved, for example, as one function of a central processing unit (CPU). The necessary-cost-information storage unit 160, the difference-information storage unit 170, and the determination-result storage unit 180 each are formed of a storage device such as a memory.

The desired commodity-purchase-information acquisition unit 110 obtains information indicating a desired purchase price per unit, on the basis of the desired commodity purchase information received from the purchaser-side user terminals 300, 400, and 500.

For each of the pieces of desired commodity purchase information received from the purchaser-side user terminals 300, 400, and 500, the desired commodity-selling-information acquisition unit 120 obtains information indicating a desired selling price, on the basis of, for example, the desired commodity selling information received from the seller-side user terminal 200 and necessary cost information which is stored in the necessary-cost-information storage unit 160 and which indicates a necessary cost (expenses necessary for sale), including a production cost and a transport cost for a commodity. A desired selling price is obtained by summing an expected profit (gross profit) indicated in the desired commodity selling information and a necessary cost indicated in the necessary cost information.

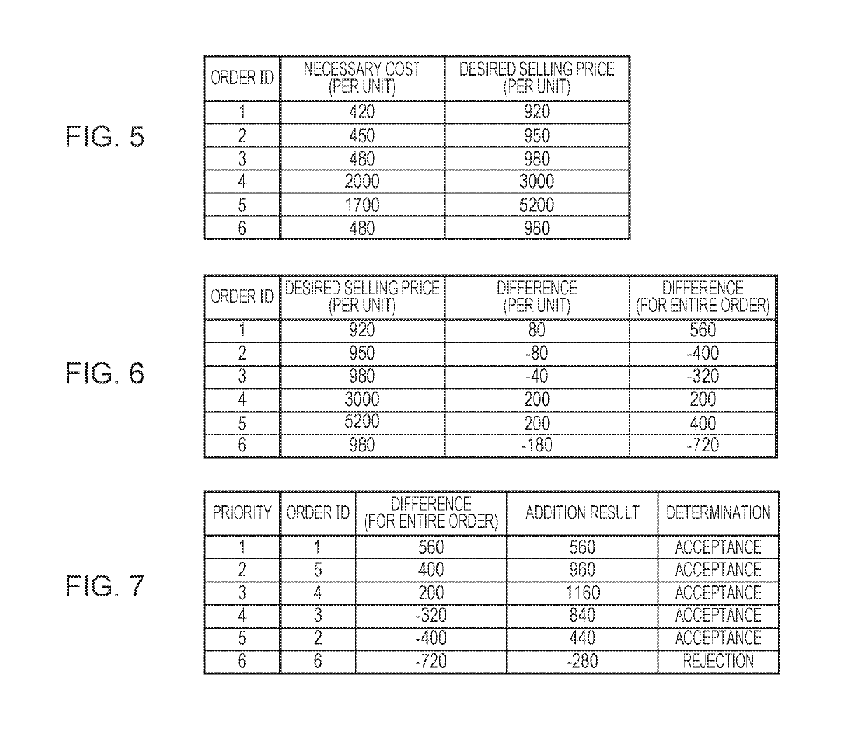

FIG. 5 is a diagram illustrating an example of necessary costs and desired selling prices. The necessary cost information indicating necessary costs is set in advance by, for example, a seller in such a manner that a necessary cost is associated with a commodity, and is stored in the necessary-cost-information storage unit 160. Costs determined by, for example, a seller for each of the properties of a delivery address are stored as delivery cost information in the necessary-cost-information storage unit 160, and a delivery cost in a necessary cost is determined by referring to delivery address information indicating a purchaser address which is included in the desired commodity purchase information transmitted from the purchaser-side user terminals 300, 400, and 500. By adding this necessary cost to an expected profit illustrated in FIG. 2, a desired selling price is obtained.

For each of the pieces of desired commodity purchase information, the difference acquisition unit 130 obtains a difference obtained by subtracting a desired selling price obtained by the desired commodity-selling-information acquisition unit 120 from a desired purchase price obtained by the desired commodity-purchase-information acquisition unit 110. FIG. 6 is a diagram illustrating an example of differences obtained by the difference acquisition unit 130. For example, as illustrated in FIG. 3, an order denoted by the order ID 1 indicates a desired purchase of seven units of a commodity denoted by the commodity ID 101 with a per-unit price of 1000 yen. In contrast, the selling price determined on the basis of conditions from a seller is 920 yen. Accordingly, the difference per unit is 80 yen, and the difference obtained from the purchase of seven units is 560 yen. The difference information indicating an obtained difference is stored in the difference-information storage unit 170.

On the basis of differences obtained for the pieces of desired commodity purchase information, the determination unit 140 accepts one or more pieces of the desired commodity purchase information that are at least some of the pieces of desired commodity purchase information and that include such differences that the total of the differences is equal to or more than zero, as those for which sales are to be made. More specifically, the addition unit 141 of the determination unit 140 accumulatively adds a difference obtained for each of the pieces of desired commodity purchase information in descending order of the difference, and sequentially obtains an addition result. Then, in the addition performed by the addition unit 141, when a new addition result that is smaller than zero is obtained by adding a difference to an addition result that is equal to or more than zero, the addition-result determination unit 142 accepts all of the pieces of desired commodity purchase information corresponding to differences that have been added before the addition of the latest added difference, as those for which sales are to be made.

FIG. 7 is a diagram describing a determination process performed by the determination unit 140. To describe the addition performed in descending order of the difference, the orders are sorted in descending order of the difference, and the sequence after the sorting is denoted by “priority”. The sorting process may be achieved by storing a table that stores information indicating differences obtained by the difference acquisition unit 130 into the difference-information storage unit 170 and actually sorting the sequence in an array on the table, or may be achieved by reading out differences in descending order of the difference by using some method in the addition. In FIG. 7, in the addition performed in sequence from the top (in descending order of the difference), since a new addition result of −280 which is smaller than zero is obtained by adding a difference of −720 for the order denoted by the order ID 6 to an addition result of 440 which is equal to or more than zero, orders that are denoted by the order IDs 1, 5, 4, 3, and 2 and that have been subjected to addition before the addition of the latest added difference are determined to be those (desired commodity purchase information) for which sales are to be made. In the figures, an order determined to be one for which a sale is made is represented by “acceptance”, and an order determined not to be one for which a sale is made is represented by “rejection”.

Information indicating the determination results obtained by the determination unit 140 is stored in the determination-result storage unit 180, and the determination process in the information processing system 1000 is ended. The determination results stored in the determination-result storage unit 180 are transmitted as appropriate via the communication unit 150 on the basis of operations by users at the seller-side user terminal 200 and the purchaser-side user terminals 300, 400, and 500, and are referred to by the users.

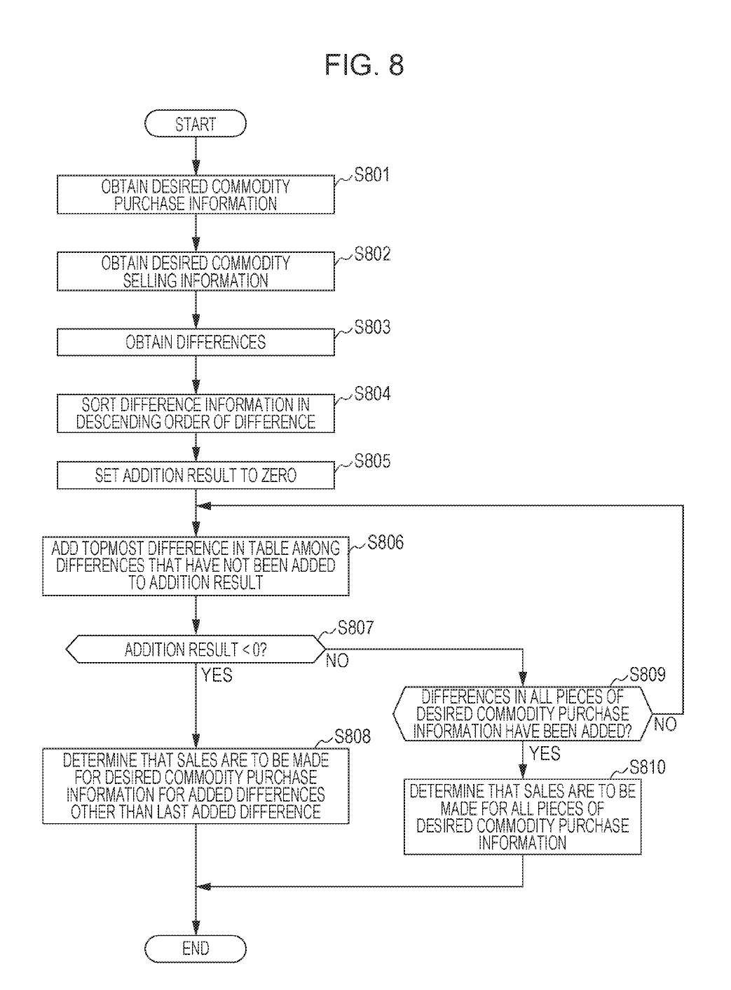

A determination process in the information processing system 1000 according to the present exemplary embodiment will be described by using a flowchart. FIG. 8 is a flowchart of a determination process in the information processing system 1000 according to the present exemplary embodiment.

The desired commodity-purchase-information acquisition unit 110 of the management apparatus 100 obtains pieces of desired commodity purchase information received from the purchaser-side user terminals 300, 400, and 500 (in step S801), and obtains desired purchase prices on the basis of the obtained pieces of desired commodity purchase information.

Then, the desired commodity-selling-information acquisition unit 120 of the management apparatus 100 obtains desired commodity selling information received from the seller-side user terminal 200 (in step S802), and obtains desired selling prices on the basis of the obtained desired commodity selling information, the necessary cost information, and the pieces of desired commodity purchase information.

Then, the difference acquisition unit 130 of the management apparatus 100 obtains a difference for each of the pieces of desired commodity purchase information, which is obtained by subtracting a desired selling price from a desired purchase price (in step S803), and stores the obtained differences in the difference-information storage unit 170 in tabular form.

Then, the determination unit 140 of the management apparatus 100 sorts the differences stored in the difference-information storage unit 170 in tabular form, in descending order of the difference, as illustrated in FIG. 7 (in step S804).

The determination unit 140 initializes an addition result so that the addition result is set to zero (in step S805), and the addition unit 141 of the determination unit 140 adds the topmost difference in the table among differences that have not been added, i.e., the topmost one in the table, to the addition result (in step S806). The addition-result determination unit 142 of the determination unit 140 determines whether or not the addition result is smaller than zero (in step S807). If the addition result is smaller than zero, the addition-result determination unit 142 determines that sales are to be made for all of the pieces of desired commodity purchase information corresponding to differences that have been added before the latest addition (in step S808), and the determination process in the management apparatus 100 is ended. In this context, since the added difference is the first one, i.e., there are no differences that have been added before the added difference, it is determined that desired purchase information to be accepted is “not present”.

In step S807, if the addition result is equal to or more than zero, the determination unit 140 determines whether or not the addition unit 141 has added all of the differences for the pieces of desired commodity purchase information (in step S809). If there is a difference that has not been added, the process returns back to step S806. If all of the differences have been added, the determination unit 140 determines that sales are to be made for all of the pieces of desired commodity purchase information (in step S810), and the determination process in the management apparatus 100 is ended.

The above-described configuration achieves the information processing system 1000 which determines pieces of desired commodity purchase information for which sales are to be made, on the basis of a desired purchase price and a desired selling price for a commodity.

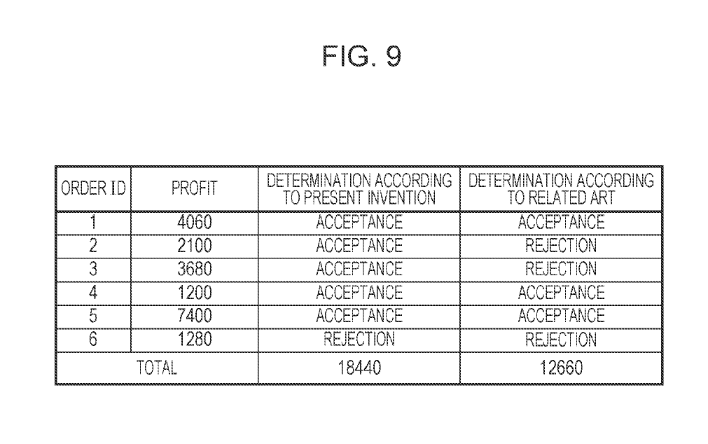

An effect achieved in the configuration according to the present exemplary embodiment will be described. FIG. 9 is a diagram describing an effect achieved in the configuration according to the present exemplary embodiment. In FIG. 9, determination results for the above-described conditions are illustrated. As described above, in the configuration according to the present exemplary embodiment, orders corresponding to the order IDs 1, 5, 4, 3, and 2, i.e., 1, 2, 3, 4, and 5, are determined to be orders for which sales are to be made. In contrast, in a configuration of the related art in which only orders, each of which has a difference which is, for example, positive, (i.e., orders in which a desired purchase price presented from a purchaser is higher than a price obtained based on conditions from a seller) are determined to be orders for which sales are to be made, it is determined that sales are to be made for orders corresponding to the order IDs 1, 4, and 5.

For each of these results, the total of the profits which are eventually obtained, i.e., the total of differences obtained by subtracting an associated cost from a desired purchase price, is calculated. For example, for the order denoted by the order ID 1, the desired purchase price is 1000 yen; the associated cost is 420 yen; and the purchase amount is 7. Accordingly, the profit is 4060 yen, i.e., (1000−420)×7. The total of the profits thus obtained is 12660 yen in the configuration of the related art, whereas the total of the profits obtained in the configuration according to the present exemplary embodiment is 18440 yen. It is found that the configuration according to the present exemplary embodiment achieves a profit larger than that of the related art.

This is because, in the configuration of the related art, determination is performed with importance being placed on having a high rate of profit, whereas, in the configuration according to the present exemplary embodiment, determination is performed with importance being placed on having a large actual profit. By employing the configuration according to the present exemplary embodiment, a profit larger than that of the related art as described above is achieved, and it is further expected that orders for which sales are made are increased, resulting in an increase in business opportunities, for example, an increase in the number of customers.

In the above-described exemplary embodiment, a configuration of the information processing system 1000 is described which includes the management apparatus 100, the seller-side user terminal 200, and the purchaser-side user terminals 300, 400, and 500 which are connected to each other via the network 900. As long as the present invention provides a configuration in which the above-described processes are performed, as a system, any configuration is employable. The configuration may be, for example, such that all of the processes are performed on a single apparatus, or such that some of the processes performed in the management apparatus 100 are made be performed on another apparatus.

In addition, in the above-described exemplary embodiment, a configuration is employed in which the determination unit 140 performs the determination process on all of the obtained pieces of desired commodity purchase information. However, the configuration employed in the present invention is not limited to this, and may be, for example, such that, in a stage in which the difference acquisition unit 130 has obtained differences, the pieces of desired commodity purchase information, each of which has a difference which is equal to or less than zero or which is negative, are not subjected to the determination process. By employing this configuration, a state in which it is determined that sales are to be made for pieces of desired commodity purchase information from which a contribution to an increase in the profit is not expected is avoided, and the load of the processes performed after that is reduced.

In addition, a configuration may be employed in which a purchaser ID is further obtained for each of the pieces of desired commodity purchase information, and in which pieces of desired commodity purchase information that are associated with an identical ID, i.e., for the same purchaser, are regarded as one piece of desired commodity purchase information which is subjected to the determination process. By employing this configuration, in the pieces of desired commodity purchase information for an identical purchaser, pieces for which it is determined that sales are to be made are not mixed with pieces for which it is determined that sales are not to be made, and an increase of the load on a purchaser in which, for example, some of the purchases need to be made again is avoided.

In the above-described exemplary embodiment, a configuration is disclosed in which a single seller-side user terminal 200 is provided and in which one piece of desired commodity selling information is obtained. For example, a configuration may be employed in which multiple seller-side user terminals 200 are provided and in which multiple sellers input pieces of desired commodity selling information, each of which is used in the determination. In addition, a configuration may be employed in which, for an identical commodity, high priority is placed on a piece of desired commodity selling information from a seller who sells the commodity at a lower price, in selecting of the desired commodity selling information.

The above-described operations of the management apparatus 100, the seller-side user terminal 200, and the purchaser-side user terminals 300, 400, and 500 are achieved by executing programs stored in a storage unit (not illustrated) provided in each of these. The programs may be provided through communication, or may be stored in a computer-readable storage medium such as a compact disc-read-only memory (CD-ROM) so as to be provided.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a desired commodity-purchase-information acquisition unit that acquires a plurality of pieces of desired commodity purchase information, each of which includes a desired purchase condition for a commodity;
a desired commodity-selling-information acquisition unit that acquires desired commodity selling information including a desired selling condition for the commodity;
a difference acquisition unit that acquires a difference obtained by subtracting a desired selling price from a desired purchase price for each of the plurality of pieces of desired commodity purchase information, the desired selling price being obtained on the basis of the desired selling information, the desired purchase price being obtained on the basis of the desired commodity purchase information; and
a determination unit that performs determination and that accepts one or more pieces of desired commodity purchase information which are at least one of the plurality of pieces of desired commodity purchase information and for which the total of the differences is equal to or more than zero, as desired commodity purchase information for which sales are to be made, on the basis of the difference obtained for each of the plurality of pieces of desired commodity purchase information.

2. The information processing system according to claim 1,
wherein the determination unit includes
an addition unit that sequentially obtains an addition result by accumulatively adding the difference obtained for each of the plurality of pieces of desired commodity purchase information, in descending order of the difference, and
a unit that, in the addition process performed by the addition unit, in the case where an addition result smaller than zero is obtained by adding a difference to an addition result equal to or more than zero, accepts all of pieces of desired commodity purchase information which correspond to differences having been added before the latest added difference as pieces of desired commodity purchase information for which sales are to be made.

3. The information processing system according to claim 1,
wherein the desired commodity-selling-information acquisition unit further acquires necessary cost information indicating a cost necessary for a sale of the commodity, and expected profit information indicating an expected profit in the sale of the commodity, and obtains the desired selling price on the basis of a sum of the cost and the expected profit.

4. The information processing system according to claim 2,
wherein the desired commodity-selling-information acquisition unit further acquires necessary cost information indicating a cost necessary for a sale of the commodity, and expected profit information indicating an expected profit in the sale of the commodity, and obtains the desired selling price on the basis of a sum of the cost and the expected profit.

5. The information processing system according to claim 1,
wherein the desired commodity purchase information further includes delivery address information indicating a delivery address for the commodity,
wherein the desired commodity selling information includes delivery cost information indicating a cost determined for each of properties of the delivery address for the commodity, and
wherein the desired commodity-selling-information acquisition unit obtains the desired selling price on the basis of the delivery address information and the delivery cost information.

6. The information processing system according to claim 2,
wherein the desired commodity purchase information further includes delivery address information indicating a delivery address for the commodity,
wherein the desired commodity selling information includes delivery cost information indicating a cost determined for each of properties of the delivery address for the commodity, and
wherein the desired commodity-selling-information acquisition unit obtains the desired selling price on the basis of the delivery address information and the delivery cost information.

7. The information processing system according to claim 3,
wherein the desired commodity purchase information further includes delivery address information indicating a delivery address for the commodity,
wherein the desired commodity selling information includes delivery cost information indicating a cost determined for each of properties of the delivery address for the commodity, and
wherein the desired commodity-selling-information acquisition unit obtains the desired selling price on the basis of the delivery address information and the delivery cost information.

8. The information processing system according to claim 4,
wherein the desired commodity purchase information further includes delivery address information indicating a delivery address for the commodity,
wherein the desired commodity selling information includes delivery cost information indicating a cost determined for each of properties of the delivery address for the commodity, and
wherein the desired commodity-selling-information acquisition unit obtains the desired selling price on the basis of the delivery address information and the delivery cost information.

9. The information processing system according to claim 1,
wherein the determination unit further includes a unit that excludes pieces of desired commodity purchase information, each of which includes a difference smaller than zero, among the plurality of pieces of desired commodity purchase information, from targets for determination.

10. The information processing system according to claim 2,
wherein the determination unit further includes a unit that excludes pieces of desired commodity purchase information, each of which includes a difference smaller than zero, among the plurality of pieces of desired commodity purchase information, from targets for determination.

11. The information processing system according to claim 3,
wherein the determination unit further includes a unit that excludes pieces of desired commodity purchase information, each of which includes a difference smaller than zero, among the plurality of pieces of desired commodity purchase information, from targets for determination.

12. The information processing system according to claim 4,
wherein the determination unit further includes a unit that excludes pieces of desired commodity purchase information, each of which includes a difference smaller than zero, among the plurality of pieces of desired commodity purchase information, from targets for determination.

13. The information processing system according to claim 5,
wherein the determination unit further includes a unit that excludes pieces of desired commodity purchase information, each of which includes a difference smaller than zero, among the plurality of pieces of desired commodity purchase information, from targets for determination.

14. The information processing system according to claim 6,
wherein the determination unit further includes a unit that excludes pieces of desired commodity purchase information, each of which includes a difference smaller than zero, among the plurality of pieces of desired commodity purchase information, from targets for determination.

15. The information processing system according to claim 7,
wherein the determination unit further includes a unit that excludes pieces of desired commodity purchase information, each of which includes a difference smaller than zero, among the plurality of pieces of desired commodity purchase information, from targets for determination.

16. The information processing system according to claim 8,
wherein the determination unit further includes a unit that excludes pieces of desired commodity purchase information, each of which includes a difference smaller than zero, among the plurality of pieces of desired commodity purchase information, from targets for determination.

17. An information processing apparatus comprising:
a desired commodity-purchase-information acquisition unit that acquires a plurality of pieces of desired commodity purchase information, each of which includes a desired purchase condition for a commodity;
a desired commodity-selling-information acquisition unit that acquires desired commodity selling information including a desired selling condition for the commodity;
a difference acquisition unit that acquires a difference obtained by subtracting a desired selling price from a desired purchase price for each of the plurality of pieces of desired commodity purchase information, the desired selling price being obtained on the basis of the desired selling information, the desired purchase price being obtained on the basis of the desired commodity purchase information; and
a determination unit that performs determination and that accepts one or more pieces of desired commodity purchase information which are at least one of the plurality of pieces of desired commodity purchase information and for which the total of the differences is equal to or more than zero, as desired commodity purchase information for which sales are to be made, on the basis of the difference obtained for each of the plurality of pieces of desired commodity purchase information.

18. A non-transitory computer readable medium storing a program causing a computer to execute a process comprising:
acquiring a plurality of pieces of desired commodity purchase information, each of which includes a desired purchase condition for a commodity;
acquiring desired commodity selling information including a desired selling condition for the commodity;
acquiring a difference obtained by subtracting a desired selling price from a desired purchase price for each of the plurality of pieces of desired commodity purchase information, the desired selling price being obtained on the basis of the desired selling information, the desired purchase price being obtained on the basis of the desired commodity purchase information; and
accepting one or more pieces of desired commodity purchase information which are at least one of the plurality of pieces of desired commodity purchase information and for which the total of the differences is equal to or more than zero, as desired commodity purchase information for which sales are to be made, on the basis of the difference obtained for each of the plurality of pieces of desired commodity purchase information.
